(19) United States
(12) Patent Application Publication
(10) Pub. No.: US 2025/0218400 A1
(43) Pub. Date: Jul. 3, 2025

(54) Display Device and Display Panel

(71) Applicant: LG Display Co., Ltd., Seoul (KR)

(72) Inventors: Daehun Kim, Paju-si (KR); Minyoung Gong, Paju-si (KR)

(21) Appl. No.: 18/769,195

(22) Filed: Jul. 10, 2024

(30) Foreign Application Priority Data
Dec. 28, 2023 (KR) 10-2023-0193988

(51) Int. Cl. G09G 3/3291; G09G 3/20; G09G 3/3233

(52) U.S. Cl. CPC G09G 3/3291; G09G 3/2092; G09G 3/3233; G09G 2300/0413; G09G 2300/0842; G09G 2300/0861; G09G 2310/0291; G09G 2330/06

(57) ABSTRACT

A display device comprises a display panel including a plurality of subpixels in a display area and a plurality of switching signal lines and a pseudo signal line in a bezel area, a data switching circuit including a plurality of switching elements configured to control a data voltage supplied to the display panel, a timing controller configured to supply a plurality of switching signals controlling the plurality of switching elements through the plurality of switching signal lines, and a pseudo signal generation circuit configured to generate a pseudo signal supplied to the pseudo signal line using the plurality of switching signals.

### CROSS-REFERENCE TO RELATED APPLICATION

This application claims priority to and benefits of Republic of Korea Patent Application No. 10-2023-0193988, filed on Dec. 28, 2023, which is hereby incorporated by reference in its entirety.

### BACKGROUND

### Technical Field

Embodiments of the disclosure relate to a display device and a display panel and, more specifically, for example, without limitation, to a display device and a display panel capable of effectively reducing noise due to electromagnetic interference caused during a display driving process.

### Description of Related Art

Representative display devices for displaying an image based on digital data include liquid crystal display (LCD) devices using liquid crystal and organic light emitting display devices using organic light emitting diodes OLEDs, etc.

Among these display devices, the organic light emitting displays adopt light emitting diodes and thus have fast responsiveness and various merits in contrast ratio, luminous efficiency, brightness, and viewing angle. In this case, the light emitting diode may be implemented with an inorganic material or an organic material.

The organic light emitting diode display include light emitting diode in subpixels arranged on the display panel and enables the light emitting diodes to emit light by controlling the current flowing to the light emitting diodes, thereby controlling the brightness represented by each subpixel while displaying an image.

The description provided in the background section should not be assumed to be prior art merely because it is mentioned in or associated with the background section. The background section may include information that describes one or more aspects of the subject technology.

### SUMMARY

Such a display device may include signal lines for transferring various signals, and magnetic fields may be generated inside and outside the display device by signals applied to the signal lines.

Due to these magnetic fields, electromagnetic waves may be generated in the display device, and electromagnetic interference may occur between the display device and other adjacent electronic devices, or in the case of a display device with a touch function, between the display driving period and the touch driving period.

As such, when electromagnetic interference occurs in the display device, malfunction may occur in the display device due to noise caused by electromagnetic interference, and image quality may deteriorate.

Therefore, there is a need to reduce noise caused by electromagnetic interference generated in display devices.

Accordingly, the inventors of the disclosure have invented a display device and a display panel capable of effectively reducing noise due to electromagnetic interference caused during a display driving process.

Exemplary embodiments of the disclosure may provide a display device and a display panel capable of effectively reducing noise for a plurality of switching signals through one pseudo signal line by reducing toggling a plurality of switching elements, controlling the data voltage applied to the display panel, in the same direction.

Exemplary embodiments of the disclosure may provide a display device and a display panel capable of implementing a narrow bezel by reducing noise for a plurality of switching signals transferred through a plurality of switching signal lines, through one pseudo signal line.

Exemplary embodiments of the disclosure may provide a display device comprising a display panel including a plurality of subpixels formed in a display area and a plurality of switching signal lines and a pseudo signal line formed in a bezel area, a data switching circuit including a plurality of switching elements controlling a data voltage supplied to the display panel, a timing controller transferring a plurality of switching signals controlling the plurality of switching elements through the plurality of switching signal lines, and a pseudo signal generation circuit generating a pseudo signal supplied to the pseudo signal line using the plurality of switching signals.

Exemplary embodiments of the disclosure may provide a display panel comprising a plurality of subpixels formed in a display area, a plurality of switching signal lines formed in a bezel area to transfer a plurality of switching signals, a pseudo signal line positioned outside the plurality of switching signal lines and transferring a pseudo signal opposite in phase to at least some of the plurality of switching signals, and a data switching circuit including a plurality of switching elements controlling a data voltage transferred through a data line according to the plurality of switching signals.

According to exemplary embodiments of the disclosure, it may be possible to effectively reduce noise due to electromagnetic interference caused during a display driving process.

According to exemplary embodiments of the disclosure, it may be possible to effectively reduce noise for a plurality of switching signals through one pseudo signal line by reducing toggling a plurality of switching elements, controlling the data voltage applied to the display panel, in the same direction.

According to exemplary embodiments of the disclosure, it may be possible to perform low-power driving and increase the lifespan of switching elements by reducing the number of times of toggling a plurality of switching elements controlling the data voltage applied to the display panel.

According to exemplary embodiments of the disclosure, it may be possible to implement a narrow bezel by reducing noise for a plurality of switching signals transferred through a plurality of switching signal lines, through one pseudo signal line.

It is to be understood that both the foregoing general description and the following detailed description are exemplary and explanatory and are intended to provide further explanation of the inventive concepts as claimed.

### BRIEF DESCRIPTION OF DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

The above and other objects, features, and advantages of the disclosure will be more clearly understood from the following detailed description, taken in conjunction with the accompanying drawings, in which:

FIG. 1 is a view schematically illustrating a display device according to exemplary embodiments of the disclosure.

FIG. 2 is a view illustrating an example of a system of a display device according to exemplary embodiments of the disclosure.

FIG. 3 is a view illustrating an example subpixel circuit in a display device according to exemplary embodiments of the disclosure.

FIG. 4 is a view illustrating an example of a switching structure controlling a data voltage in a display device according to exemplary embodiments of the disclosure.

FIG. 5 is a view illustrating an example structure in which a pseudo signal line is disposed in a display device according to exemplary embodiments of the disclosure.

FIG. 6 is a view illustrating an example waveform of a pseudo signal for reducing noise due to a switching signal in a display device according to exemplary embodiments of the disclosure.

FIG. 7 is a signal waveform diagram illustrating an example in which switching signals for controlling the operation of switching elements connected to a data line overlap in some period in a display device according to exemplary embodiments of the disclosure.

FIGS. 8A and 8B are a signal waveform diagram and a corresponding table, illustrating an example of reducing noise by one pseudo signal when three switching signals for controlling a data voltage overlap in a display device according to exemplary embodiments of the disclosure.

FIG. 9 is a signal waveform diagram illustrating an example of controlling switching signals to prevent an overlapping period in which a plurality of switching signals are toggled to a turn-on level at the same time in a display device according to exemplary embodiments of the disclosure.

FIG. 10 is a block diagram illustrating a structure of generating a plurality of switching signals and a pseudo signal in a display device according to exemplary embodiments of the disclosure.

FIG. 11 is a view illustrating an example of a pseudo signal generation circuit and a driving table in a display device according to exemplary embodiments of the disclosure.

FIG. 12 is a view illustrating waveforms of a plurality of switching signals and a pseudo signal generated from a pseudo signal generation circuit in a display device according to exemplary embodiments of the disclosure.

FIGS. 13A and 13B are graphs illustrating the results of noise cancellation by one pseudo signal for a case where times when some of a plurality of switching signals are toggled overlap and a case where a plurality of switching signals are not toggled at the same time in a display device according to exemplary embodiments of the disclosure.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Hereinafter, some embodiments of the disclosure will be described in detail with reference to exemplary drawings. In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting”, “make up of”, and “formed of” used herein are generally intended to allow other components to be added unless the terms are used with the term “only”. As used herein, singular forms are intended to include plural forms unless the context clearly indicates otherwise. Names of the respective elements used in the following explanations may be selected only for convenience of writing the specification and may be thus different from those used in actual products.

Advantages and features of the present disclosure, and implementation methods thereof will be clarified through following example embodiments described with reference to the accompanying drawings. The present disclosure may, however, be embodied in different forms and should not be construed as limited to example embodiments set forth herein. Rather, these example embodiments may be provided so that this disclosure may be sufficiently thorough and complete to assist those skilled in the art to fully understand the scope of the present disclosure. Further, the present disclosure is only defined by scopes of claims.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”. Any implementation described herein as an “example” is not necessarily to be construed as preferred or advantageous over other implementations.

The terms, such as “below,” “lower,” “above,” “upper” and the like, may be used herein to describe a relationship between element(s) as illustrated in the drawings. It will be understood that the terms are spatially relative and based on the orientation depicted in the drawings.

For example, the meaning of “at least one of a first element, a second element, and a third element” encompass the combination of all three listed elements, combinations of any two of the three elements, as well as each individual element, the first element, the second element, or the third element.

Features of various embodiments of the present disclosure may be partially or overall coupled to or combined with each other, and may be variously inter-operated with each other and driven technically as those skilled in the art can sufficiently understand. Embodiments of the present disclosure may be carried out independently from each other, or may be carried out together in co-dependent relationship.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood by one of ordinary skill in the art.

Hereinafter, various exemplary embodiments of the disclosure will be described in detail with reference to the accompanying drawings.

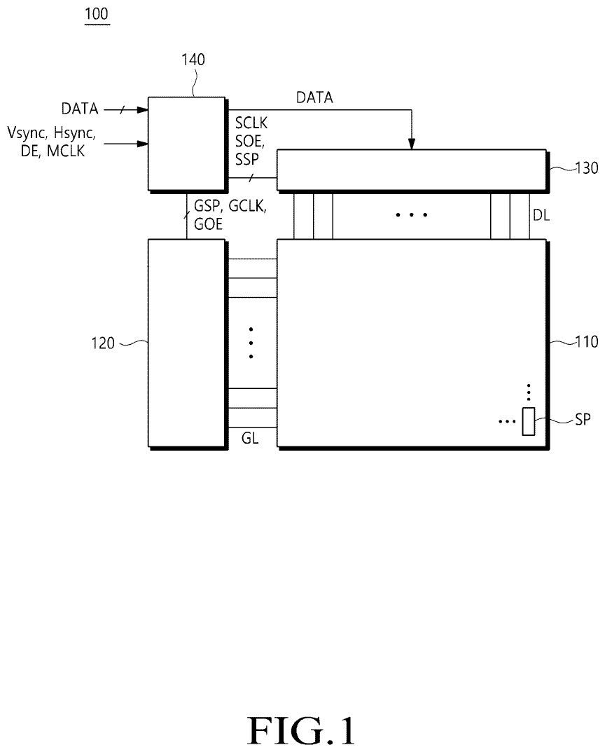

FIG. 1 is a view schematically illustrating a display device according to exemplary embodiments of the disclosure;

Referring to FIG. 1, a display device 100 according to exemplary embodiments of the disclosure may include a display panel 110 where a plurality of gate lines GL and data lines DL are connected, and a plurality of subpixels SP are arranged in a matrix form in a display area, a gate driving circuit 120 providing signals to the plurality of gate lines GL, a data driving circuit 130 supplying a data voltage through the plurality of data lines DL, and a timing controller 140 controlling the gate driving circuit 120 and the data driving circuit 130.

The display panel 110 displays an image based on a scan signal transferred from the gate driving circuit 120 through the plurality of gate line GLs GL and the data voltage transferred from the data driving circuit 130 through the plurality of data lines DL.

In the case of a liquid crystal display, the display panel 110 may include a liquid crystal layer formed between two substrates and may be operated in any known mode, such as a twisted nematic (TN) mode, a vertical alignment (VA) mode, an in-plane switching (IPS) mode, or a fringe field switching (FFS) mode, without being limited thereto. In the case of an organic light emitting display, the display panel 110 may be implemented in a top emission scheme, a bottom emission scheme, or a dual-emission scheme.

In the display panel 110, a plurality of pixels may be arranged in a matrix form, and each pixel may include subpixels SP having different colors, e.g., a white subpixel, a red subpixel, a green subpixel, and a blue subpixel, and each subpixel SP may be defined by the plurality of data lines DL and the plurality of gate lines GL. Embodiments are not limited thereto. As an example, each pixel may include a red subpixel, a green subpixel, and a blue subpixel. Subpixels of other colors may be alternatively or additionally included.

One subpixel SP may include, e.g., a thin film transistor (TFT) disposed in an area defined by one data line DL and one gate line GL, a light emitting element, such as a light emitting diode, that emits light according to a voltage corresponding to a data voltage, and a storage capacitor electrically connected to the light emitting element to maintain the voltage.

For example, when the display device 100 having a resolution of 2,160×3,840 includes four subpixels SP of white (W), red (R), green (G), and blue (B), 3,840 data lines DL and 2,160 gate lines GL may be connected to each of the four subpixels WRGB, and thus, there may be provided 3,840×4=15,360 data lines DL. Each subpixel SP is disposed in the area defined by the gate line GL and the data line DL.

The gate driving circuit 120 may be controlled by the controller 140 to sequentially output scan signals to the plurality of gate lines GL disposed in the display panel 110, controlling the driving timing of the plurality of subpixels SP.

In the display device 100 having a resolution of 2,160×3,840, sequentially outputting the scan signal to the 2,160 gate lines GL from the first gate line to the 2,160th gate line may be referred to as 2,160-phase driving. Sequentially outputting the scan signal to each unit of four gate lines GL, e.g., sequentially outputting the scan signal to the fifth gate line to the eighth gate line after sequentially outputting the scan signal to the first gate line to the fourth gate line, is referred to as 4-phase driving. In other words, sequentially outputting the scan signal to every N gate lines GL may be referred to as N-phase driving.

The gate driving circuit 120 may include one or more gate driving integrated circuits (GDICs). Depending on driving schemes, the gate driving circuit 120 may be positioned on only one side, or each of two opposite sides, of the display panel 110. The gate driving circuit 120 may be implemented in a gate-in-panel (GIP) type in which it is directly formed in the bezel area of the display panel 110. The bezel area may correspond to a non-display area other than the display area where subpixels are disposed. Embodiments are not limited thereto. As an example, the gate driving circuit 120 may be separately provided (for example, on a separate panel), and then connected to the display panel 110 in a tape automated bonding (TAB) method, a chip on glass (COG) method, a chip on panel (COP) method, or a chip on film (COF) method, without being limited thereto.

The data driving circuit 130 receives digital image data DATA from the timing controller 140 and converts the received digital image data DATA into an analog data voltage. Then, as the data voltage is output to each data line DL according to the timing when the scan signal is applied through the gate line GL, each subpixel SP connected to the data line DL displays a light emitting signal having the brightness corresponding to the data voltage.

Likewise, the data driving circuit 130 may include one or more source driving integrated circuits SDIC, and the source driving integrated circuit SDIC may be connected to the bonding pad of the display panel 110 in a tape automated bonding (TAB) type or a chip-on-glass (COG) type or may be disposed directly on the display panel 110, without being limited thereto.

In some cases, each source driving integrated circuit SDIC may be integrated and disposed on the display panel 110. Further, each source driving integrated circuit SDIC may be implemented in a chip-on-film (COF) type and, in this case, each source driving integrated circuit SDIC may be mounted on a circuit film and may be electrically connected to the data line DL of the display panel 110 through the circuit film.

The timing controller 140 supplies various control signals to the gate driving circuit 120 and the data driving circuit 130 and controls the operation of the gate driving circuit 120 and the data driving circuit 130. As an example, the timing controller 140 may control the gate driving circuit 120 to output a scan signal according to the timing implemented in each frame and, on the other hand, transfer the digital image data DATA received from the outside to the data driving circuit 130.

In this case, the timing controller 140 receives, from the outside (e.g., a host system), several timing signals including, e.g., a vertical synchronization signal Vsync, a horizontal synchronization signal Hsync, a data enable signal DE, and a main clock MCLK, together with the digital image data DATA. Accordingly, the timing controller 140 may generate a control signal according to various timing signals received from the outside and transfer the control signal to the gate driving circuit 120 and the data driving circuit 130.

For example, the timing controller 140 outputs several gate control signals including, e.g., a gate start pulse GSP, a gate clock GCLK, and a gate output enable signal GOE, to control the gate driving circuit 120, without being limited thereto. The gate start pulse GSP controls the timing at which one or more gate driving integrated circuits GDIC constituting the gate driving circuit 120 start operation. The gate clock GCLK is a clock signal commonly input to one or more gate driving integrated circuits GDIC and controls the shift timing of the scan signal. The gate output enable signal GOE designates timing information about one or more gate driving integrated circuits GDICs.

The timing controller 140 outputs various data control signals including, e.g., a source start pulse SSP, a source sampling clock SCLK, and a source output enable signal SOE, to control the data driving circuit 130, without being limited thereto. The source start pulse SSP controls the timing at which one or more source driving integrated circuits SDIC constituting the data driving circuit 130 start data sampling. The source sampling clock SCLK is a clock signal that controls the timing of sampling data in the source driving integrated circuit SDIC. The source output enable signal SOE controls the output timing of the data driving circuit 130.

The display device 100 may further include a power management integrated circuit that supplies various voltages or currents to, e.g., the display panel 110, the timing controller 140, the gate driving circuit 120, and/or the data driving circuit 130 or controls various voltages or currents to be supplied.

Meanwhile, a light emitting element may be disposed in each subpixel SP. For example, the organic light emitting diode display may include a light emitting element, such as a light emitting diode, in each subpixel SP and may display an image by controlling the current flowing to the light emitting element according to the data voltage.

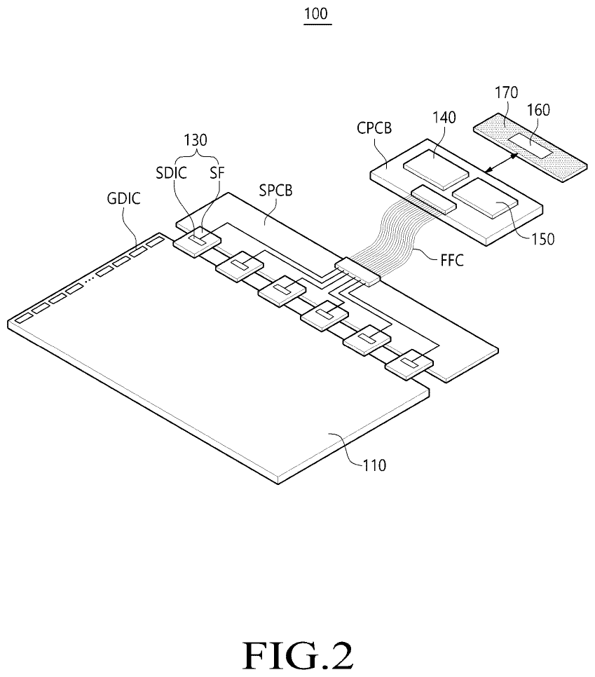

FIG. 2 is a view illustrating an example of a system of a display device according to exemplary embodiments of the disclosure;

Referring to FIG. 2, in the display device 100 according to exemplary embodiments of the disclosure, the source driving integrated circuit SDIC included in the data driving circuit 130 is implemented in a chip-on-film (COF) type among various types (e.g., TAB, COG, or COF), and the gate driving circuit 120 is implemented in a gate-in-panel (GIP) type among various types (e.g., TAB, COG, COF, or GIP), without being limited thereto.

When the gate driving circuit 120 is implemented in the GIP type, the plurality of gate driving integrated circuits GDIC included in the gate driving circuit 120 may be directly formed in the bezel area of the display panel 110. In this case, the gate driving integrated circuits GDIC may receive various signals (e.g., a clock signal, a gate high signal, a gate low signal, etc.) necessary for generating scan signals SCAN through gate driving-related signal lines disposed in the bezel area.

Likewise, one or more source driving integrated circuits SDIC included in the data driving circuit 130 each may be mounted on the source film SF, and one side of the source film SF may be electrically connected to the display panel 110. Lines for electrically connecting the source driver integrated circuit SDIC and the display panel 110 may be disposed on the source film SF.

The display device 100 may include at least one source printed circuit board SPCB for circuit connection between a plurality of source driving integrated circuits SDIC and other devices and a control printed circuit board CPCB for mounting control components and various electric devices.

The other side of the source film SF where the source driving integrated circuit SDIC is mounted may be connected to at least one source printed circuit board SPCB. As an example, one side of the source film SF where the source driving integrated circuit SDIC is mounted may be electrically connected with the display panel 110, and the other side thereof may be electrically connected with the source printed circuit board SPCB.

The timing controller 140 and the power management integrated circuit (PMIC) 150 may be mounted on the control printed circuit board CPCB. The timing controller 140 may control the operation of the data driving circuit 130 and the gate driving circuit 120. The power management integrated circuit 150 may supply driving voltage or current to the display panel 110, the timing controller 140, the data driving circuit 130, and/or the gate driving circuit 120 and control the supplied voltage or current.

At least one source printed circuit board SPCB and control printed circuit board CPCB may be circuit-connected through at least one connection member. The connection member may include, e.g., a flexible printed circuit FPC or a flexible flat cable FFC, without being limited thereto. The at least one source printed circuit board SPCB and control printed circuit board CPCB may be integrated into a single printed circuit board.

As an example, the display device 100 may further include a set board 170 electrically connected to the control printed circuit board CPCB. As an example, the set board 170 may also be referred to as a power board. A main power management circuit (M-PMC) 160 for managing the overall power of the display device 100 may be disposed on the set board 170. The main power management circuit 160 may interwork with the power management integrated circuit 150. Embodiments are not limited thereto. As an example, at least one of the power management integrated circuit 150 and the main power management circuit 160 may be omitted. As an example, the display panel 110 may receive the driving voltage or current from an external device other than the power management integrated circuit 150 and the main power management circuit 160. As an example, at least two of the source printed circuit board SPCB, the control printed circuit board CPCB and the set board 170 may be integrated into a single printed circuit board.

In the so-configured display device 100, the driving voltage is generated in the set board 170 and transferred to the power management integrated circuit 150 in the control printed circuit board CPCB. The power management integrated circuit 150 transfers a driving voltage necessary for display driving or characteristic value sensing, etc., to the source printed circuit board SPCB, for example, through the flexible printed circuit FPC or flexible flat cable FFC. The driving voltage transferred to the source printed circuit board SPCB is supplied to emit light or sense a specific subpixel SP in the display panel 110 through the source driving integrated circuit SDIC.

Each of the subpixels SP arranged in the display panel 110 in the display device 100 may include a light emitting element and a circuit element, e.g., a driving transistor, for driving the light emitting diode.

The type and number of circuit elements constituting each subpixel SP may vary depending on functions to be provided and design schemes.

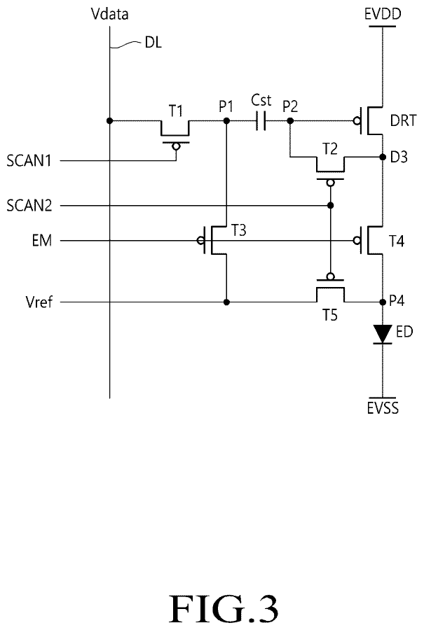

FIG. 3 is a view illustrating an example subpixel circuit in a display device according to exemplary embodiments of the disclosure.

Referring to FIG. 3, the subpixel circuit of the display device 100 according to exemplary embodiments of the disclosure may include a light emission element ED, a driving transistor DRT, a plurality of switching transistors T1 to T5, and a storage capacitor Cst. Embodiments are not limited thereto. As an example, the subpixel circuit of the display device 100 may include more or less transistors and more or less storage capacitors. As an example, the subpixel circuit of the display device 100 may include at least two transistors and at least one storage capacitor, without being limited thereto.

The driving transistor DRT and the plurality of switching transistors T1 to T5 included in the subpixel circuit may be implemented as PMOS type low temperature poly silicon (LTPS) transistors, thereby securing a desired response characteristic.

Alternatively, at least one of the plurality of switching transistors T1 to T5 may be implemented as an NMOS type or a PMOS type oxide transistor having good leakage current characteristics when turned off, and the remaining switching transistors may be implemented as PMOS type LTPS transistors having good response characteristics. Embodiments are not limited thereto. As an example, the driving transistor DRT and the plurality of switching transistors T1 to T5 included in the subpixel circuit may be implemented as either a PMOS type transistor or a NMOS type transistor. As an example, the driving transistor DRT and the plurality of switching transistors T1 to T5 included in the subpixel circuit may be implemented as transistors including any semiconductors, such as an oxide semiconductor, a poly silicon semiconductor, an amorphous silicon semiconductor, a compound semiconductor, an organic semiconductor, etc., without being limited thereto.

The light emission element ED emits light by a driving current adjusted according to the gate-source voltage Vgs of the driving transistor DRT. The anode electrode of the light emission element ED is connected to the fourth node P4, and the cathode electrode of the light emission element ED is connected to the low-potential pixel voltage EVSS.

When the light emission device ED is an organic light emission diode, an organic compound layer is provided between the anode electrode and the cathode electrode.

The organic compound layer may include a hole injection layer HIL, a hole transport layer HTL, an emission layer EML, an electron transport layer ETL, and an electron injection layer EIL. For example, two or more organic compound layers emitting different colors of light may be stacked according to a tandem structure. Embodiments are not limited thereto. As an example, at least one of the hole injection layer HIL, the hole transport layer HTL, the electron transport layer ETL, and the electron injection layer EIL may be omitted.

When a driving current flows through the light emission device ED, holes passing through the hole transport layer HTL and electrons passing through the electron transport layer ETL move to the light emission layer EML to form excitons, and as a result, the light emission layer EML may emit light, such as visible light or even invisible light.

The driving transistor DRT controls a current flowing through the light emission element ED according to the gate-source voltage Vgs. The gate electrode of the driving transistor DRT is connected to the second node P2, the drain electrode (or source electrode) is connected to a driving voltage line supplying the high-potential pixel voltage EVDD, and the source electrode (or drain electrode) is connected to the third node P3.

The subpixel circuit may include a first switching transistor T1 to a fifth switching transistor T5 capable of sampling the gate-source voltage Vgs and a storage capacitor Cst to compensate for the threshold voltage or mobility of the driving transistor DRT.

The first switching transistor T1 is connected between the data line DL and the first node P1, and is switched according to the first scan signal SCAN1. The gate electrode of the first switching transistor T1 is connected to the first gate line to which the first scan signal SCAN1 is applied, the drain electrode (or source electrode) is connected to the data line DL, and the source electrode (or drain electrode) is connected to the first node P1.

The second switching transistor T2 is connected between the second node P2 and the third node P3, and is switched according to the second scan signal SCAN2. The gate electrode of the second switching transistor T2 is connected to the second gate line to which the second scan signal SCAN2 is applied, the drain electrode (or source electrode) is connected to the third node P3, and the source electrode (or drain electrode) is connected to the second node P2.

Since one electrode of the second switching transistor T2 is connected to the gate electrode of the driving transistor DRT, it is preferable that the second switching transistor T2 has good Off current characteristics. Accordingly, as an example, the second switching transistor T2 may be designed in a dual gate structure to suppress leakage current when turned off, without being limited thereto.

In the dual gate structure, the first gate electrode and the second gate electrode are connected to each other to have the same potential, and the channel length is longer than that of the single gate structure. As the channel length increases, the resistance increases, and the leakage current decreases when turned off, so that stability of operation may be secured. However, the second switching transistor T2 may be implemented as a single gate structure. As an example, the second switching transistor T2 may be implemented as an oxide transistor of a single gate structure, without being limited thereto.

The third switching transistor T3 is connected between the first node P1 and the reference voltage line to which the reference voltage Vref is applied, and is switched according to the light emission signal EM. The gate electrode of the third switching transistor T3 is connected to the third gate line to which the light emission signal EM is applied, the drain electrode (or source electrode) is connected to the first node P1, and the source electrode (or drain electrode) is connected to the reference voltage line.

The fourth switching transistor T4 is connected between the third node P3 and the fourth node P4, which is the anode electrode of the light emission element ED, and is switched according to the light emission signal EM. The gate electrode of the fourth switching transistor T4 is connected to the third gate line to which the light emission signal EM is applied, the drain electrode (or source electrode) is connected to the third node P3, and the source electrode (or drain electrode) is connected to the fourth node P4. Since the fourth switching transistor T4 controls the driving current flowing through the light emission element ED, it may be referred to as a light emission control transistor.

The fifth switching transistor T5 is connected between the fourth node P4 and the reference voltage line, and is switched according to the second scan signal SCAN2. The gate electrode of the fifth switching transistor T5 is connected to the second gate line to which the second scan signal SCAN2 is applied, the drain electrode (or source electrode) is connected to the fourth node P4, and the source electrode (or drain electrode) is connected to the reference voltage line.

The storage capacitor Cst is connected between the first node P1 and the second node P2.

Further, the display device 100 of the disclosure may reduce noise through a switching circuit that controls the data voltage Vdata applied through the data line DL.

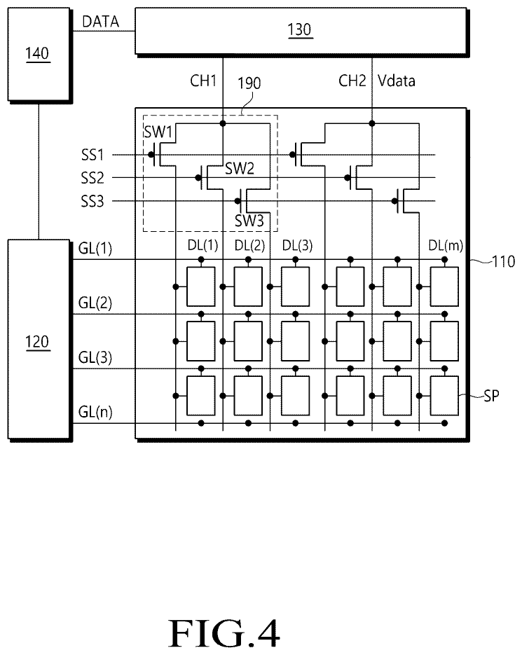

FIG. 4 is a view illustrating an example of a switching structure controlling a data voltage in a display device according to exemplary embodiments of the disclosure.

Referring to FIG. 4, in the display device 100 according to exemplary embodiments of the disclosure, the data driving circuit 130 sequentially inputs and latches image data DATA input from the timing controller 140, for example, line by line, without being limited thereto.

The latched line-by-line image data DATA is converted into data voltage Vdata using a gamma voltage and a digital-to-analog converter, and then is output through the plurality of data channels CH1 and CH2 according to a source output enable signal.

A data switching circuit 190 may include a plurality of switching elements SW1, SW2, and SW3, and may selectively supply the data voltage Vdata transferred through the data channels CH1 and CH2 of the data driving circuit 130 to the data lines DL(1)-DL(m) of the display panel 110 according to the switching signals SS1, SS2, and SS3, for example, output from the timing controller 140. The plurality of switching elements SW1, SW2, and SW3 may be transistors that are turned on or off by the switching signals SS1, SS2, and SS3, respectively.

For example, when the plurality of switching elements SW1, SW2, and SW3 are P-type transistors (e.g., P-type metal oxide semiconductor (MOS) transistors), the plurality of switching elements SW1, SW2, and SW3 may be turned on by the low-level switching signals SS1, SS2, and SS3, and may supply the data voltage Vdata transferred through the channels CH1 and CH2 through the selected data lines DL(1)-DL(m). Embodiments are not limited thereto. For example, the plurality of switching elements SW1, SW2, and SW3 may be N-type transistors, and the plurality of switching elements SW1, SW2, and SW3 may be turned on by the high-level switching signals SS1, SS2, and SS3.

The data switching circuit 190 may function as a multiplexer for controlling a connection between one data channel (e.g., CH1) and a plurality of data lines (e.g., DL(1), DL(2), and DL(3)). Although it is described and illustrated that one data channel is connected to three data lines herein, embodiments are not limited thereto. For example, one data channel may be connected to one data line. As another example, one data channel may be connected to at least two data lines. Accordingly, as an example, there could be at least two switching elements and at least two switching signals, the number of which may correspond to (e.g., equal to) the number of the at least two data lines. In addition, although it is described and illustrated that there are two data channels, embodiments are not limited thereto. As an example, there may be more than two data channels.

The data switching circuit 190 may supply the data voltage Vdata output from one data channel (e.g., CH1) extending from the data driving circuit 130 according to the switching signals SS1, SS2, and SS3 through the data line selected from the three data lines DL1, DL2, and DL3.

As an example, when the first switching signal SS1 is applied at the turn-on level, the data switching circuit 190 may supply a data voltage output from each of the data channels CH1 and CH2 of the data driving circuit 130 to a data line (e.g., the DL 1) of a first color (e.g., red).

When the second switching signal SS2 is applied at the turn-on level, the data voltage output from each of the data channels CH1 and CH2 of the data driving circuit 130 may be supplied to a data line (e.g., the DL 2) of a second color (e.g., green).

When the third switching signal SS3 is applied at the turn-on level, the data voltage output from each of the data channels CH1 and CH2 of the data driving circuit 130 may be supplied to a data line (e.g., the DL 3) of a third color (e.g., blue).

Here, it is exemplified that the data switching circuit 190 includes three switching elements SW1, SW2, and SW3, and supplies the data voltage Vdata transferred through one data channel CH1 or CH2 to the three data lines DL(1), DL(2), and DL(3) according to the three switching signals SS1, SS2, and SS3. However, the data switching circuit 190 is not limited thereto, and may supply a data voltage output from one data channel CH1 or CH2 to m data lines DL(1)-DL(m) according to a plurality of switching signals. As an example, m may be a natural number equal to or greater than 2.

In this case, since the switching signals SS1, SS2, and SS3 for driving the data switching circuit 190 operate at a high frequency, noise due to electromagnetic interference may be generated. As an example, during the transition process of the switching signals SS1, SS2, and SS3 for driving the data switching circuit 190, a capacitance may be generated between adjacent data lines, and noise may be generated due to electromagnetic interference between the data lines.

In order to reduce the noise, the display device 100 according to exemplary embodiments of the disclosure may reduce the noise caused by the switching signals SS1, SS2, and SS3 by disposing at least one pseudo signal line in the bezel area of the display panel 110 and applying a pseudo signal that is opposite in phase to the switching signals SS1, SS2, and SS3.

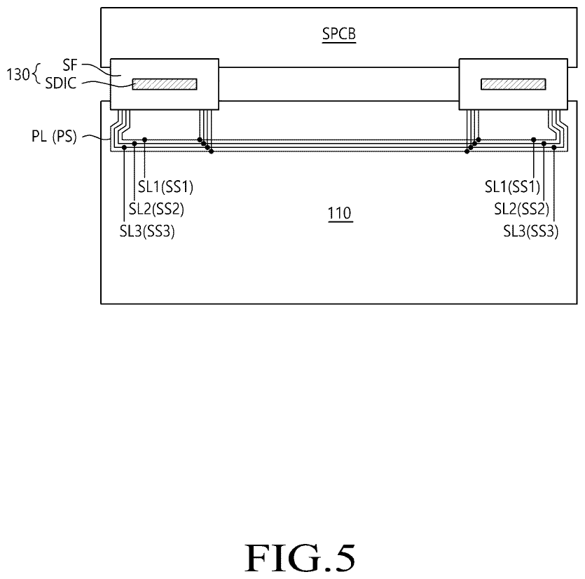

FIG. 5 is a view illustrating an example structure in which a pseudo signal line is disposed in a display device according to exemplary embodiments of the disclosure.

Referring to FIG. 5, in the display device 100 according to exemplary embodiments of the disclosure, the switching signal lines SL1, SL2, and SL3 transferring the switching signals SS1, SS2, and SS3 for controlling the switching element connected between the data channel and the data line may extend along the bezel area of the display panel 110.

Specifically, the plurality of switching signal lines SL1, SL2, and SL3 may extend along the side surface of the source film SF on which the source driving integrated circuit SDIC is mounted, and may extend along the bezel area of the display panel 110 adjacent to the data driving integrated circuit 130. In this case, as an example, the plurality of switching signal lines SL1, SL2, and SL3 may be formed in a multi-feeding structure branching from a plurality of points to reduce resistance, without being limited thereto.

Meanwhile, the pseudo signal line PL transferring the pseudo signal PS may extend in the bezel area of the display panel 110. As an example, the pseudo signal line PL transferring the pseudo signal PS may extend in parallel with the switching signal lines SL1, SL2, and SL3 in the bezel area of the display panel 110. As an example, the pseudo signal line PL transferring the pseudo signal PS may extend along the outer side of the switching signal lines SL1, SL2, and SL3 in the bezel area of the display panel 110. In this case, since the switching signal lines SL1, SL2, and SL3 are disposed in an area adjacent to the data driving circuit 130 and the pseudo signal line PL is disposed outside the switching signal lines SL1, SL2, and SL3, the pseudo signal line PL may be disposed farther from the data driving circuit 130 than the switching signal lines SL1, SL2, and SL3. Embodiments are not limited thereto. As an example, the pseudo signal line PL may be disposed farther from the data driving circuit 130 than at least one of the switching signal lines SL1, SL2, and SL3, or may be disposed closer to the data driving circuit 130 than the switching signal lines SL1, SL2, and SL3 (for example, by extending along an inner side of the switching signal lines SL1, SL2, and SL3 in the bezel area of the display panel 110).

Electromagnetic interference caused by the switching signals SS1, SS2, and SS3 may be at least partially offset by applying the pseudo signal PS at least partially opposite in phase to the switching signals SS1, SS2, and SS3 to the pseudo signal line PL extending along the outer side of the switching signal lines SL1, SL2, and SL3.

As an example, the pseudo signal PS is a signal having a phase opposite to that of the switching signals SS1, SS2, and SS3 and transferred through the pseudo signal line PL disposed adjacent to the switching signal lines SL1, SL2, and SL3 in order to reduce electromagnetic interference generated during the transition of the switching signals SS1, SS2, and SS3.

In this case, as the radiation amount of the pseudo signal PS becomes more similar to the radiation amount of the switching signals SS1, SS2, and SS3, the effect of reducing electromagnetic noise may increase. To that end, it may be effective to form the sum of the line widths of the pseudo signal lines PL and the sum of the line widths of the switching signal lines SL1, SL2, and SL3 to be the same or similar.

However, the same number of pseudo signal lines PL as the number of switching signal lines SL1, SL2, and SL3 may be formed, but a smaller number of pseudo signal lines PL than the number of switching signal lines SL1, SL2, and SL3 may be formed considering the width of the bezel area. Here, it is shown that one pseudo-signal line PL is formed corresponding to the three switching signal lines SL1, SL2, and SL3. Embodiments are not limited thereto. As an example, two or more pseudo-signal line PL may be formed corresponding to the three switching signal lines SL1, SL2, and SL3.

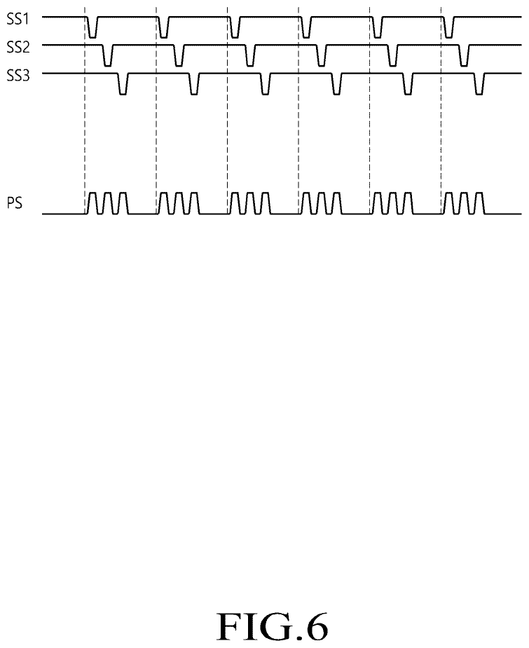

FIG. 6 is a view illustrating an example waveform of a pseudo signal for reducing noise due to a switching signal in a display device according to exemplary embodiments of the disclosure.

Referring to FIG. 6, the display device 100 according to exemplary embodiments of the disclosure may supply a pseudo signal PS opposite in phase to the switching signal SS1, SS2, and SS3 applied through the switching signal lines SL1, SL2, and SL3 disposed in the bezel area to the pseudo signal line PSL, thereby cancelling noise caused by the switching signal SS1, SS2, and SS3.

Here, it is exemplified that the plurality of switching elements SW1, SW2, and SW3 are formed of P-type MOS transistors and are turned on by low-level switching signals SS1, SS2, and SS3, without being limited thereto.

In this case, the three switching signals SS1, SS2, and SS3 may form pulses at different times while each having a high level and a low level, and thus one pseudo signal PS that is opposite in phase to the three switching signals SS1, SS2, and SS3 may be generated.

As described above, the display device 100 according to the disclosure may reduce noise caused by the switching signals SS1, SS2, and SS3 for controlling the data voltage Vdata by applying a pseudo signal PS having an opposite phase along the pseudo signal line PL disposed in the bezel area at the time when the switching signals SS1, SS2, and SS3 are toggled.

In this case, as an example, data of a specific color or a specific pattern may be continuously displayed according to the type of the image displayed on the display panel 110. Accordingly, since the lifetime of the switching elements SW1, SW2, and SW3 transferring the data voltage Vdata may be shortened and the image quality of the display panel 110 may deteriorate, as an example, the switching signals SS1, SS1, and SS3 may be generated so that the turn-on periods of the switching signals SS1, SS2, and SS3 partially overlap each other.

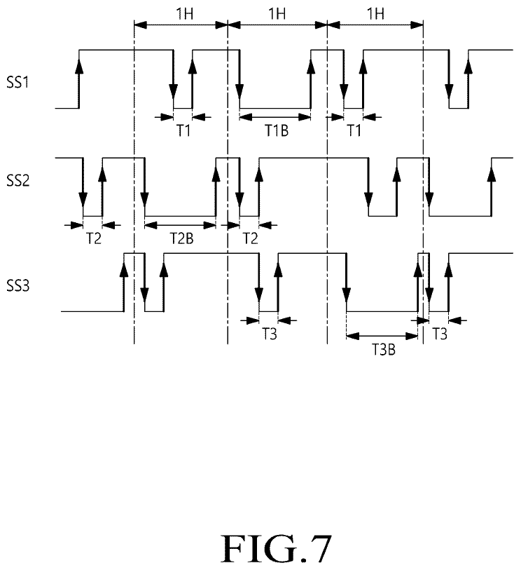

FIG. 7 is a signal waveform diagram illustrating an example in which switching signals for controlling the operation of switching elements connected to a data line overlap in some period in a display device according to exemplary embodiments of the disclosure.

Referring to FIG. 7, the display device 100 according to exemplary embodiments of the disclosure may control the operation of the plurality of switching elements SW1, SW2, and SW3 connected to the data line using the switching signals SS1, SS2, and SS3 applied through the plurality of switching signal lines SL1, SL2, and SL3 disposed in the bezel area.

When the plurality of switching elements SW1, SW2, and SW3 are P-type MOS transistors, the plurality of switching elements SW1, SW2, and SW3 may be turned on by the low-level switching signals SS1, SS2, and SS3, without being limited thereto.

For example, the three switching signals SS1, SS2, and SS3 may be toggled while each having a high level and a low level, and may form pulses of the turn-on level at different times.

In this case, as an example, when data of a specific color or a specific pattern is continuously input, the lifetime of the switching elements SW1, SW2, and SW3 may be shortened and the image quality of the display panel 110 may deteriorate. Therefore, in order to solve this problem, the switching signals SS1, SS2, and SS3 may be generated so that the turn-on periods of the switching signals SS1, SS2, and SS3 may partially overlap.

For example, the first switching signal SS1 may include a plurality of first turn-on periods T1 for turning on the first switching element SW1, the second switching signal SS2 may include a plurality of second turn-on periods T2 for turning on the second switching element SW2, and the third switching signal SS3 may include a plurality of third turn-on periods T3 for turning on the third switching element SW3.

In this case, between the plurality of first turn-on periods T1 for turning on the first switching element SW1, a first buffering period TIB for switching the first switching signal SS1 of the turn-off level to the turn-on level for a predetermined time may be included.

Here, the first buffering period TIB may at least partially overlap the second turn-on period T2 in which the second switching element SW2 is turned on or the third turn-on period T3 in which the third switching element SW3 is turned on. Accordingly, the first switching element SW1 may also be turned on in a partial period overlapping the second turn-on period T2 in which the second switching element SW2 is turned on or the third turn-on period T3 in which the third switching element SW3 is turned on. As a result, time intervals when the first switching element SW1 is turned on and off may be effectively allocated, and image quality of pixels (red subpixels, green subpixels, and blue subpixels) controlled by the first switching element SW1, the second switching element SW2, and the third switching element SW3 may be maintained harmoniously.

Further, even between the plurality of second turn-on periods T2 for turning on the second switching element SW2, a second buffering period T2B for switching the second switching signal SS2 of the turn-off level to the turn-on level for a predetermined time may be included. In this case, the second buffering period T2B may at least partially overlap the first turn-on period T1 in which the first switching element SW1 is turned on or the third turn-on period T3 in which the third switching element SW3 is turned on.

Further, even between the plurality of third turn-on periods T3 for turning on the third switching element SW3, a third buffering period T3B for switching the third switching signal SS3 of the turn-off level to the turn-on level for a predetermined time may be included. In this case, the third buffering period T3B may at least partially overlap the first turn-on period T1 in which the first switching element SW1 is turned on or the second turn-on period T2 in which the second switching element SW2 is turned on.

As described above, when some periods of the plurality of switching signals SS1, SS2, and SS3 for controlling the operation of the plurality of switching elements SW1, SW2, and SW3 overlap each other, the times when some of the plurality of switching signals SS1, SS2, and SS3 are toggled may overlap each other, and thus it may be difficult to cancel the noise at the time when the switching signals SS1, SS2, and SS3 are toggled using one pseudo signal PS.

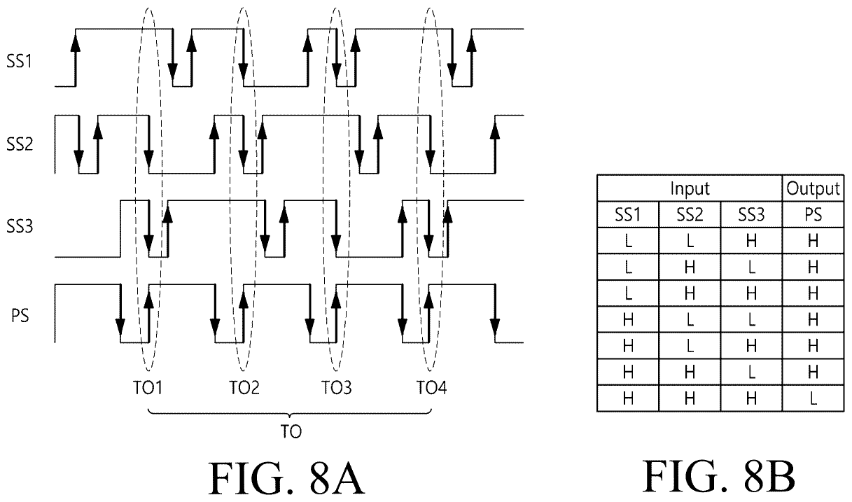

FIGS. 8A and 8B show a signal waveform diagram and a corresponding table illustrating an example of reducing noise by one pseudo signal when three switching signals for controlling a data voltage overlap in a display device according to exemplary embodiments of the disclosure.

Referring to FIGS. 8A and 8B, when data of a specific color or a specific pattern is continuously input, the lifetime of the specific switching elements SW1, SW2, and SW3 transferring the data voltage Vdata may be shortened and the image quality of the display panel 110 may be deteriorated. Thus, the display device 100 according to exemplary embodiments of the disclosure may perform overlapping driving so that the turn-on periods of the switching signals SS1, SS2, and SS3 partially overlap each other.

As described above, in the case of overlapping driving in which some periods of the switching signals SS1, SS2, and SS3 for controlling the operation of the switching elements SW1, SW2, and SW3 overlap each other, the times when the switching signals SS1, SS2, and SS3 are toggled may overlap each other. Thus, it may be difficult to cancel the noise at the time when the switching signals SS1, SS2, and SS3 are toggled using one pseudo signal PS.

Here, an example of generating the pseudo signal PS through the NAND gate receiving the three switching signals SS1, SS2, and SS3 is illustrated.

For example, when driving is performed so that some periods of the three switching signals SS1, SS2, and SS3 for controlling the operations of the three switching elements SW1, SW2, and SW3 overlap each other, periods (e.g., a first overlapping period TO1 and a fourth overlapping period TO4) in which the second switching signal SS2 and the third switching signal SS3 are toggled while overlapping each other at the turn-on level L may occur. Further, a period (e.g., a second overlapping period TO2) in which the first switching signal SS1 and the second switching signal SS2 are toggled while overlapping at the turn-on level L and a period (e.g., a third overlapping period TO3) in which the first switching signal SS1 and the third switching signal SS3 are toggled while overlapping at the turn-on level L may occur.

In this case, in the overlapping period TO in which two of the three switching signals SS1, SS2, and SS3 are toggled while overlapping, it becomes difficult to cancel the noise of the switching signals SS1, SS2, and SS3 using one pseudo signal PS.

The display device 100 according to the disclosure may control the switching signal so that the overlapping period in which the plurality of switching signals are toggled to the turn-on level at the same time does not occur, thereby cancelling the noise of the plurality of switching signals using one pseudo signal.

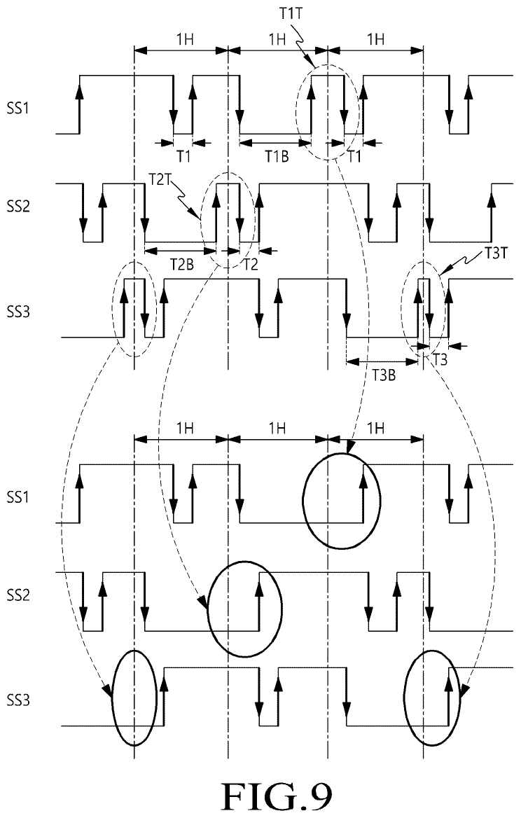

FIG. 9 is a signal waveform diagram illustrating an example of controlling switching signals to reduce or prevent an overlapping period in which a plurality of switching signals are toggled to a turn-on level at the same time in a display device according to exemplary embodiments of the disclosure.

Referring to FIG. 9, the display device 100 according to exemplary embodiments of the disclosure may generate switching signals SS1, SS2, and SS3 for controlling the plurality of switching elements SW1, SW2, and SW3 constituting the data switching circuit 190 by the timing controller 140.

In this case, the first switching signal SS1 may include a plurality of first turn-on periods T1 for turning on the first switching element SW1, the second switching signal SS2 may include a plurality of second turn-on periods T2 for turning on the second switching element SW2, and the third switching signal SS3 may include a plurality of third turn-on periods T3 for turning on the third switching element SW3.

A first buffering period TIB for switching the first switching signal SS1 of the turn-off level to the turn-on level for a predetermined time may be included between the plurality of first turn-on periods T1 for turning on the first switching element SW1. Here, the first buffering period T1B may at least partially overlap the second turn-on period T2 in which the second switching element SW2 is turned on or the third turn-on period T3 in which the third switching element SW3 is turned on.

In this case, the first turn-on period T1 in which the first switching signal SS1 is toggled to the turn-on level may overlap the second buffering period T2B of the second switching signal SS2 or the third buffering period T3B of the third switching signal SS3. Here, the time when the first switching signal SS1 is toggled to the turn-on level overlaps the time when the third switching signal SS3 is toggled to the turn-on level in the third buffering period T3B.

In this case, the timing controller 140 may remove the first toggling period TIT between the first buffering period T1B and the first turn-on period T1. In other words, when it is determined that the time when the first switching signal SS1 is toggled to the turn-on level overlaps the time when the third switching signal SS3 is toggled to the turn-on level in the third buffering period T3B, the timing controller 140 may maintain the first buffering period T1B and the first turn-on period T1 at a constant turn-on level without generating the first toggling period TIT between the first buffering period T1B and the first turn-on period T1. In this case, since the first toggling period TIT corresponds to a period in which the data voltage Vdata is not supplied to the first switching element SW1, the quality of the image emitted by the display panel 110 is not affected.

As a result, as the overlapping period in which the first switching signal SS1 and the third switching signal SS3 are toggled to the turn-on level at the same time may be removed, noise for the plurality of switching signals SS1, SS2, and SS3 may be effectively canceled using one pseudo signal PS.

Further, a second buffering period T2B for switching the second switching signal SS2 of the turn-off level to the turn-on level for a predetermined time may be included between the plurality of second turn-on periods T2 for turning on the second switching element SW2. In this case, the second buffering period T2B may at least partially overlap the first turn-on period T1 in which the first switching element SW1 is turned on or the third turn-on period T3 in which the third switching element SW3 is turned on.

Further, the second turn-on period T2 in which the second switching signal SS2 is toggled to the turn-on level may overlap the first buffering period T1B of the first switching signal SS1 or the third buffering period T3B of the third switching signal SS3. Illustrated here is an example in which the time when the second switching signal SS2 is toggled to the turn-on level overlaps the time when the first switching signal SS1 is toggled to the turn-on level in the first buffering period T1B.

In this case, the timing controller 140 may remove the second toggling period T2T between the second buffering period T2B and the second turn-on period T2. In other words, when it is determined that the time when the second switching signal SS2 is toggled to the turn-on level and the time when the first switching signal SS1 is toggled to the turn-on level in the first buffering period T1B overlap, the timing controller 140 may maintain the second buffering period T2B and the second turn-on period T2 at the same turn-on level without generating the second toggling period T2T between the second buffering period T2B and the second turn-on period T2.

As a result, since the overlapping period in which the second switching signal SS2 and the first switching signal SS1 are toggled to the turn-on level at the same time may be removed, noise for the plurality of switching signals SS1, SS2, and SS3 may be effectively canceled using one pseudo signal PS.

Further, the third turn-on period T3 in which the third switching signal SS3 is toggled to the turn-on level may overlap the first buffering period T1B of the first switching signal SS1 or the second buffering period T2B of the second switching signal SS2. Illustrated here is an example in which the time when the third switching signal SS3 is toggled to the turn-on level overlaps the time when the second switching signal SS2 is toggled to the turn-on level in the second buffering period T2B.

In this case, the timing controller 140 may remove the third toggling period T3T between the third buffering period T3B and the third turn-on period T3. In other words, when it is determined that the time when the third switching signal SS3 is toggled to the turn-on level and the time when the second switching signal SS2 is toggled to the turn-on level in the second buffering period T2B overlap each other, the timing controller 140 may maintain the third buffering period T3B and the third turn-on period T3 at the same turn-on level without generating the third toggling period T3T between the third buffering period T3B and the third turn-on period T3.

As a result, since the overlapping period in which the third switching signal SS3 and the second switching signal SS2 are toggled to the turn-on level at the same time may be removed, noise for the plurality of switching signals SS1, SS2, and SS3 may be effectively canceled using one pseudo signal PS.

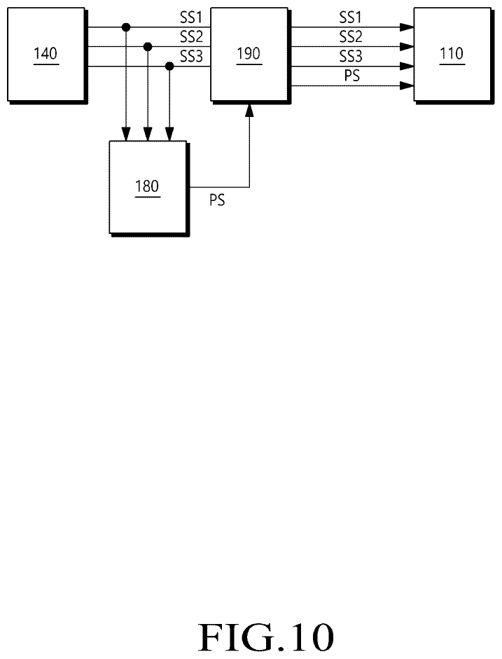

FIG. 10 is a block diagram illustrating a structure of generating a plurality of switching signals and a pseudo signal in a display device according to exemplary embodiments of the disclosure.

Referring to FIG. 10, a display device 100 according to exemplary embodiments of the disclosure may include a timing controller 140 generating a plurality of switching signals SS1, SS2, and SS3, a pseudo signal generation circuit 180 generating a pseudo signal PS using the plurality of switching signals SS1, SS2, and SS3, a data switching circuit 190 selectively supplying a data voltage Vdata according to the plurality of switching signals SS1, SS2, and SS3, and a display panel 110 in which switching signal lines where the plurality of switching signals SS1, SS2, and SS3 are transferred, and a pseudo signal line where the pseudo signal PS is transferred are formed in a bezel area. Although it is illustrated that the timing controller 140 and the pseudo signal generation circuit 180 are separate blocks, embodiments are not limited thereto. For example, the timing controller 140 and the pseudo signal generation circuit 180 may be integrated into a single controller.

The timing controller 140 generates a plurality of switching signals SS1, SS2, and SS3 for controlling the plurality of switching elements SW1, SW2, and SW3 constituting the data switching circuit 190. In this case, as described above, when it is determined that there is an overlapping period in which at least two of the plurality of switching signals SS1, SS2, and SS3 are toggled to the turn-on level at the same time, the timing controller 140 may remove the toggling period between the buffering period and the turn-on period for the switching signal including the overlapping period, thereby reducing or preventing the plurality of switching signals SS1, SS2, and SS3 from being toggled to the turn-on level at the same time. Embodiments are not limited thereto. As an example, the timing controller 140 may generate the switching signals SS1, SS2, and SS3 such that there is no overlapping period in which at least two of the plurality of switching signals SS1, SS2, and SS3 are toggled to the turn-on level at the same time.

The data switching circuit 190 may include a plurality of switching elements SW1, SW2, and SW3 controlled by the plurality of switching signals SS1, SS2, and SS3. The data switching circuit 190 may further include an amplifier for maintaining the levels of the plurality of switching signals SS1, SS2, and SS3 and the pseudo signal PS at the same level, or a phase delay circuit for matching the phases of the plurality of switching signals SS1, SS2, and SS3 and the pseudo signal PS.

In the bezel area of the display panel 110, the switching signal lines where the plurality of switching signals SS1, SS2, and SS3 are transferred and the pseudo signal line where the pseudo signal PS is transferred may be formed.

The display device 100 according to the disclosure may reduce or prevent the plurality of switching signals SS1, SS2, and SS3 from being toggled to the turn-on level at the same time, and thus only one pseudo signal line may be formed to cancel noise caused by the plurality of switching signals SS1, SS2, and SS3 transferred through the plurality of switching signal lines.

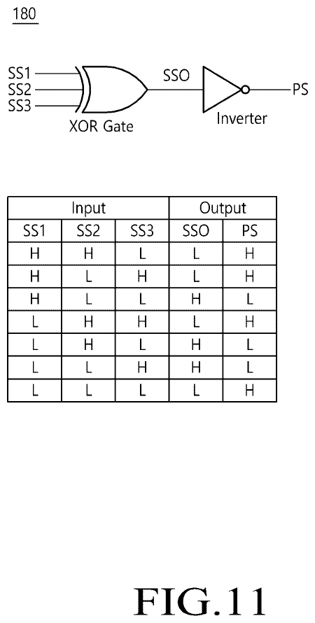

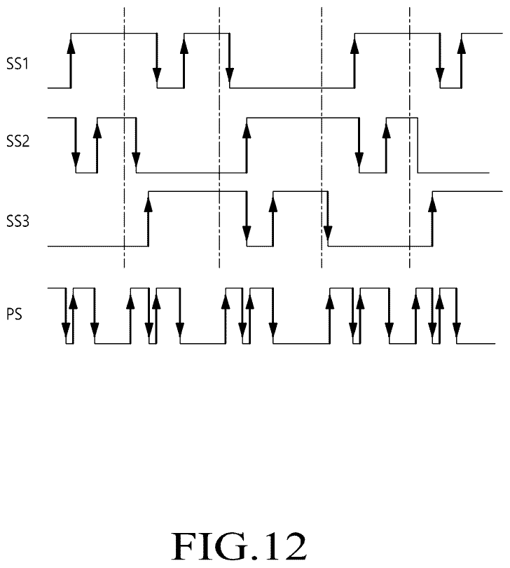

FIG. 11 is a view illustrating an example of a pseudo signal generation circuit and a driving table in a display device according to exemplary embodiments of the disclosure. FIG. 12 is a view illustrating waveforms of a plurality of switching signals and a pseudo signal generated from a pseudo signal generation circuit in a display device according to exemplary embodiments of the disclosure.

Referring to FIGS. 11 and 12, the timing controller 140 of the display device 100 according to exemplary embodiments of the disclosure may remove the toggling period between the buffering period and the turn-on period for the switching signal including the overlapping period, thereby reducing or preventing the plurality of switching signals SS1, SS2, and SS3 from being toggled to the turn-on level at the same time.

The pseudo signal generation circuit 180 may include an XOR logic gate and an inverter.

In this case, the XOR logic gate generates the switching output signal SS0 of the low level L only in the period in which an odd number of switching signals among the plurality of switching signals SS1, SS2, and SS3 transferred from the timing controller 140 are applied at the turn-on level L, and generates the switching output signal SS0 of the high level H in the period in which an even number of switching signals are applied at the turn-on level L.

The inverter inverts the switching output signal SS0.

Accordingly, the pseudo signal PS output through the pseudo signal generation circuit 180 exhibits the high level H only for the period in which an odd number of switching signals are applied at the turn-on level L.

In other words, since the timing controller 140 generates the plurality of switching signals SS1, SS2, and SS3 not toggle to the turn-on level at the same time, the display device 100 according to the disclosure may cancel the noise caused by the plurality of switching signals SS1, SS2, and SS3 through one pseudo signal PS generated by the pseudo signal generation circuit 180 including the XOR logic gate and the inverter. Embodiments are not limited thereto. As an example, as long as the pseudo signal generation circuit 180 outputs the pseudo signal PS exhibiting the high level H only for the period in which an odd number of switching signals are applied at the turn-on level L, the pseudo signal generation circuit 180 may comprise any logic gate other than the XOR logic gate and the inverter.

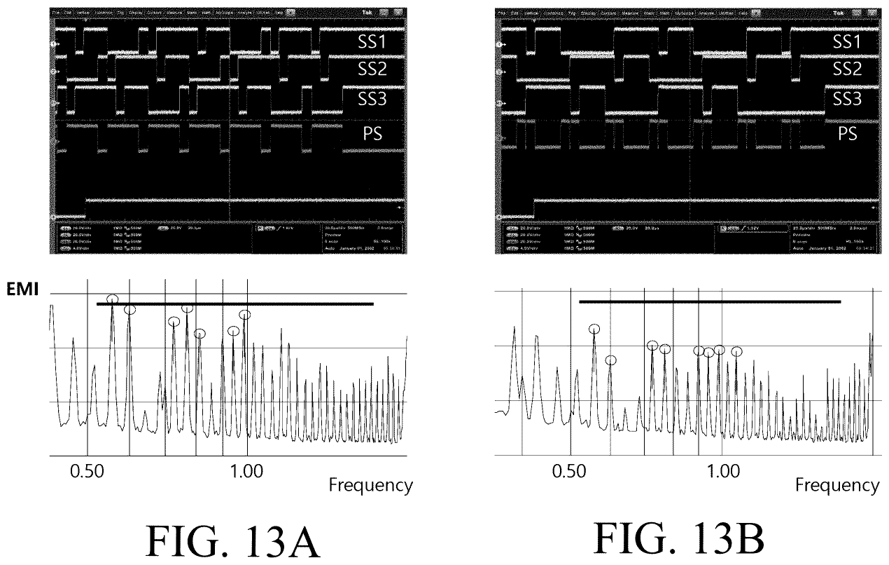

FIGS. 13A and 13B are graphs illustrating the results of noise cancellation by one pseudo signal for a case where times when some of a plurality of switching signals are toggled overlap and a case where a plurality of switching signals are not toggled at the same time in a display device according to exemplary embodiments of the disclosure.

Referring to FIG. 13A, in the display device 100 according to exemplary embodiments of the disclosure, when there is an overlapping period in which the plurality of switching signals SS1, SS2, and SS3 are toggled to the turn-on level at the same time, it may be difficult to effectively cancel the noise using one pseudo signal.

However, referring to FIG. 13B, when the timing controller 140 generates the plurality of switching signals SS1, SS2, and SS3 so as not toggle to the turn-on level at the same time, it may be identified that noise caused by the plurality of switching signals SS1, SS2, and SS3 is effectively canceled through one pseudo signal PS.

Embodiments of the disclosure described above are briefly described below.

A display device according to exemplary embodiments of the disclosure may comprise a display panel including a plurality of subpixels formed in a display area and a plurality of switching signal lines and a pseudo signal line formed in a bezel area, a data switching circuit including a plurality of switching elements controlling a data voltage supplied to the display panel, a timing controller transferring a plurality of switching signals controlling the plurality of switching elements through the plurality of switching signal lines, and a pseudo signal generation circuit generating a pseudo signal supplied to the pseudo signal line using the plurality of switching signals.

The pseudo signal line may be disposed along an area adjacent to a data driving circuit applying the data voltage.

The plurality of switching signal lines may be disposed between the data driving circuit and the pseudo signal line.

The plurality of switching elements may include a first switching element connected between a first data channel and a data line of a red subpixel, a second switching element connected between the first data channel and a data line of a green subpixel, and a third switching element connected between the first data channel and a data line of a blue subpixel.

The plurality of switching elements may include a P-type MOS transistor.

The plurality of switching signals may include a turn-on period for turning on the plurality of switching elements and a buffering period for switching a signal of a turn-off level to a turn-on level for a predetermined time between turn-on periods.

The timing controller may control not to generate an overlapping period in which the plurality of switching signals are toggled to the turn-on level at the same time.

The timing controller may remove a toggling period between the buffering period and the turn-on period.

The timing controller may maintain a period between the buffering period and the turn-on period of the first switching signal as the turn-on level when it is determined that a time when a first switching signal among the plurality of switching signals is toggled to the turn-on level overlaps a time when a second switching signal is toggled to the turn-on level in the buffering period.

The pseudo signal generation circuit may include a logic gate generating a low-level switching output signal only in a period in which an odd number of switching signals among the plurality of switching signals are applied at a turn-on level and an inverter generating the pseudo signal by inverting the switching output signal.

The logic gate may be an XOR gate.

The data switching circuit may further include an amplifier for maintaining the plurality of switching signals and the pseudo signal at the same level.

The data switching circuit may further include a phase delay circuit matching phases of the plurality of switching signals and the pseudo signal.

A display panel according to the disclosure may comprise a plurality of subpixels formed in a display area, a plurality of switching signal lines formed in a bezel area to transfer a plurality of switching signals, a pseudo signal line positioned outside the plurality of switching signal lines and transferring a pseudo signal opposite in phase to at least some of the plurality of switching signals, and a data switching circuit including a plurality of switching elements controlling a data voltage transferred through a data line according to the plurality of switching signals.

The plurality of switching signals may be controlled not to generate an overlapping period in which the plurality of switching signals are toggled to the turn-on level at the same time.

The plurality of switching signals may be maintained at the turn-on level between the buffering period and the turn-on period of the first switching signal when it is determined that a time when a first switching signal among the plurality of switching signals is toggled to the turn-on level overlaps a time when a second switching signal is toggled to the turn-on level in the buffering period.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure.

What is claimed:

1. A display device, comprising:
a display panel including a plurality of subpixels in a display area and a plurality of switching signal lines and a pseudo signal line in a bezel area;
a data switching circuit including a plurality of switching elements configured to control a data voltage supplied to the display panel;
a timing controller configured to supply a plurality of switching signals that control the plurality of switching elements through the plurality of switching signal lines; and
a pseudo signal generation circuit configured to generate a pseudo signal supplied to the pseudo signal line using the plurality of switching signals.

2. The display device of claim 1, wherein the pseudo signal line is along an area adjacent to a data driving circuit that is configured to supply the data voltage of the bezel area.

3. The display device of claim 2, wherein the plurality of switching signal lines are between the data driving circuit and the pseudo signal line.

4. The display device of claim 2, wherein the plurality of switching signal lines and the pseudo signal line extend along a side surface of a source film on which the data driving circuit is mounted.

5. The display device of claim 1, wherein the plurality of switching elements include:
a first switching element connected between a first data channel and a data line of a red subpixel;
a second switching element connected between the first data channel and a data line of a green subpixel; and
a third switching element connected between the first data channel and a data line of a blue subpixel.

6. The display device of claim 1, wherein the plurality of switching elements include a P-type MOS transistor.

7. The display device of claim 1, wherein each of the plurality of switching signals include:
a turn-on period during which a corresponding one of the plurality of switching elements is turned on; and
a buffering period during which a signal of a turn-off level is switched to a turn-on level and the turn-on level is maintained for a predetermined time between turn-on periods.

8. The display device of claim 7, wherein the timing controller controls not to generate an overlapping period in which at least two of the plurality of switching signals are toggled to the turn-on level at a same time.

9. The display device of claim 7, wherein the timing controller removes a toggling period between the buffering period and the turn-on period of at least one switching signal of the plurality of switching signals.

10. The display device of claim 9, wherein a time when the at least one switching signal is toggled to the turn-on level in the turn-on period and a time when another switching signal among the plurality of switching signals is toggled to the turn-on level in the buffering period overlap each other.

11. The display device of claim 9, wherein the toggling period corresponds to a standby state in which a corresponding switching element controlled by the at least one switching signal waits for an input of the data voltage.

12. The display device of claim 7, wherein the timing controller maintains a period between the buffering period and the turn-on period of a first switching signal as the turn-on level based on overlapping between a time when the first switching signal among the plurality of switching signals is toggled to the turn-on level in the turn-on period and a time when a second switching signal among the plurality of switching signals is toggled to the turn-on level in the buffering period.

13. The display device of claim 7, wherein the turn-on period of a first switching signal of the plurality of switching signals is separated from the turn-on period of at least one switching signal of remaining switching signals of the plurality of switching signals, and the buffering period of the first switching signal overlaps the turn-on period of the at least one switching signal.

14. The display device of claim 13, wherein the turn-on period of the first switching signal overlaps the buffering period of the at least one switching signal.

15. The display device of claim 1, wherein the pseudo signal generation circuit includes:
a logic gate configured to generate a low-level switching output signal in a period in which an odd number of switching signals among the plurality of switching signals are applied at a turn-on level; and
an inverter configured to generate the pseudo signal by inverting the low-level switching output signal.

16. The display device of claim 15, wherein the logic gate is an XOR gate.

17. The display device of claim 1, wherein the pseudo signal generation circuit is configured to:
generate the pseudo signal of a turn-off level in a period in which an odd number of switching signals among the plurality of switching signals are applied at a turn-on level, and
generate the pseudo signal of a turn-on level in a period in which an even number of switching signals among the plurality of switching signals are applied at a turn-on level.

18. The display device of claim 1, wherein the data switching circuit further includes an amplifier configured to maintain levels of the plurality of switching signals and the pseudo signal at a same level.

19. The display device of claim 1, wherein the data switching circuit further includes a phase delay circuit configured to match phases of the plurality of switching signals and the pseudo signal.

20. A display panel, comprising:
a plurality of subpixels in a display area;
a plurality of switching signal lines in a bezel area to transfer a plurality of switching signals;
a pseudo signal line outside the plurality of switching signal lines and transferring a pseudo signal opposite in phase to at least some of the plurality of switching signals; and
a data switching circuit including a plurality of switching elements configured to control a data voltage transferred through a data line according to the plurality of switching signals.

21. The display panel of claim 20, wherein the pseudo signal line is along an area adjacent to a data driving circuit configured to supply the data voltage of the bezel area.

22. The display panel of claim 21, wherein the plurality of switching signal lines are between the data driving circuit and the pseudo signal line.

23. The display panel of claim 20, wherein each of the plurality of switching signals include:
a turn-on period during which a corresponding one of the plurality of switching elements is turned on; and
a buffering period during which a signal of a turn-off level is switched to a turn-on level and the turn-on level is maintained for a predetermined time between turn-on periods.

24. The display panel of claim 23, wherein the plurality of switching signals are controlled not to generate an overlapping period in which at least two of the plurality of switching signals are toggled to the turn-on level at a same time.

25. The display panel of claim 23, wherein the plurality of switching signals are maintained at the turn-on level between the buffering period and the turn-on period of a first switching signal based on overlapping between a time when the first switching signal among the plurality of switching signals is toggled to the turn-on level in the turn-on period and a time when a second switching signal among the plurality of switching signals is toggled to the turn-on level in the buffering period.
